(19) United States
(12) Patent Application Publication
(10) Pub. No.: US 2010/0151990 A1
(43) Pub. Date: Jun. 17, 2010

(54) METHOD AND DEVICE FOR COMPENSATING A TRANSMITTED TORQUE OF A DISCONNECTING CLUTCH OR A HYBRID CLUTCH OF A HYBRID DRIVE

(76) Inventor: Andreas Seel, Bonn (DE)

Correspondence Address: KENYON & KENYON LLP, ONE BROADWAY, NEW YORK, NY, 10004, US

(21) Appl. No.: 12/529,862

(22) PCT Filed: Mar. 5, 2008
(86) PCT No.: PCT/EP2008/052679

§ 371 Date: Jan. 27, 2010

(30) Foreign Application Priority Data
Mar. 6, 2007 (DE) 10 2007 010 770.8

(51) Int. Cl. B60W 20/00; G06F 19/00; B60W 10/02; B60W 10/08; B60K 6/387; B60K 6/48

(52) U.S. Cl. 477/5; 701/22; 180/65.25; 180/65.28; 903/946; 903/914

(57) ABSTRACT

A method and a device for compensating a transmitted torque of a clutch between a regulated drive motor, in particular an electric motor, and an internal combustion engine of a hybrid drive when transitioning from an exclusive operation using the drive motor to a hybrid operation, a total torque from the drive motor and the internal combustion engine being jointly provided in hybrid operation, the rotational speed of the drive motor being controlled or regulated with the aid of a manipulated variable; the internal combustion engine being entrained at a controllable transmitted torque by coupling to the drive motor via a proportional clutch for performing the transition. The rotational speed of the drive motor is controlled or regulated as a function of a setpoint transmitted torque using which the drive motor is to be coupled to the internal combustion engine.

### FIELD OF THE INVENTION

The present invention relates to a method and a device for compensating a transmitted torque of a disconnecting clutch or a hybrid clutch of a hybrid drive.

### BACKGROUND INFORMATION

Hybrid drives of motor vehicles usually include an internal combustion engine and at least one drive motor in the form of an electric motor, so that the motor vehicles may optionally be driven in a purely electric operation by the electric motor, in a pure engine mode by the internal combustion engine, or in a hybrid operation by both the electric motor and the internal combustion engine

To start the internal combustion engine when transitioning from purely electric operation into the hybrid operation with the aid of the electric motor using a so-called “slip start,” hybrid vehicles are usually equipped with a so-called disconnecting clutch or hybrid clutch between the electric motor and the internal combustion engine which, when engaged, connects the output shaft of the electric motor to that of the internal combustion engine. The disconnecting clutch or hybrid clutch is normally designed as a sliding clutch or as a proportional clutch, a proportional clutch being a clutch which, contrary to a purely switching clutch, allows a desired transmitted torque to be set.

When the disconnecting clutch or hybrid clutch is activated and engaged during a purely electric operation of the hybrid vehicle in order to start the internal combustion engine by transmitting the set transmitted torque to the internal combustion engine, a slip occurs during a certain period of time at the disconnecting clutch or hybrid clutch between the output shaft of the electric motor and that of the internal combustion engine, until the latter rotates at the same speed as the former, wherefrom the name “slip start” originates.

In certain cases, the rotational speed of the electric motor is regulated during a slip start. However, the transmitted torque absorbed by the disconnecting clutch or hybrid clutch for overcoming the friction and for rotationally accelerating the internal combustion engine interferes with this speed regulation, resulting in a drop in the rotational speed of the electric motor. In the event of a great system deviation between the actual and setpoint rotational speeds of the electric motor, a strong jolt can be felt in the vehicle.

To avoid this jolt, German Patent Application No. 10 2007 010 770.8 describes that a correction quantity in the form of a transmitted torque of the disconnecting clutch or hybrid clutch be added to a manipulated variable output by a speed controller of the electric motor in the form of a positioning torque in order to pre-control the setpoint torque of the electric motor. If an actual transmitted torque measured or estimated via the magnitude of the pressing forces of the clutch disks of the disconnecting or hybrid clutch is used as the transmitted torque. This has, however, the disadvantage that, due to the CAN propagation time and the time needed for building up the actual torque in the electric motor, there is a time offset between the request of the actual transmitted torque used for the pre-control, fed back by the disconnecting clutch or hybrid clutch, and the implementation of the setpoint torque into an actual torque in the electric motor. The time offset causes a delay between the implementation of the setpoint transmitted torque in the disconnecting clutch or hybrid clutch and the implementation of the pre-controlled setpoint torque in the electric motor. Since the actual transmitted torque is built up in the disconnecting clutch or hybrid clutch in the shape of a ramp, a “slip offset” may occur, i.e., a time difference between the fed-back actual transmitted torque and the buildup of a corresponding actual torque in the electric motor, which may also result in a drop in the rotational speed and a jolt at the time of the engine start.

German Patent Application No. 10 2007 010 770.8 suggests that, instead of a measured value or an estimated value, which is derived based on the quantities measured in the disconnecting clutch or hybrid clutch, the specification for the transmitted torque may also correspond to a clutch manipulated variable, which is provided by a hybrid operation control circuit of the disconnecting clutch or hybrid clutch to set the corresponding transmitted torque.

### SUMMARY

An object of the present invention is to provide further and farther-reaching options for making the transition from purely electric operation to hybrid operation in a vehicle having a hybrid drive more comfortable, and in particular to avoid a drop in the total torque in the drive train when starting the internal combustion engine and thus a perceptible jolt of the vehicle.

In accordance with an example embodiment of the present invention, the rotational speed of the drive motor is controlled as a function of a setpoint transmitted torque of the disconnecting clutch or hybrid clutch using which the drive motor is coupled to the internal combustion engine, and that a component for providing a setpoint transmitted torque be provided, the speed controller being designed to control the speed of the drive motor as a function of the setpoint transmitted torque.

It is preferably further provided that the rotational speed of the drive motor is controlled or regulated to set an actual rotational speed to a setpoint rotational speed and that a positioning torque, output by the speed controller or regulator as a manipulated variable, is increased by the desired setpoint transmitted torque to obtain a corrected manipulated variable in the form of a setpoint torque.

Since the setpoint transmitted torque in the disconnecting clutch or hybrid clutch is in reality not ideal but is implemented with a certain time delay, as well as with a gradient limitation and a so-called PT1 filtering, the setpoint transmitted torque is similarly subject to a time delay, a slope limitation, and a PT1 filtering prior to the correction of the manipulated variable.

### BRIEF DESCRIPTION OF THE DRAWINGS

The present invention is explained in detail below with reference to the exemplary embodiments depicted in the figures.

FIG. 1 schematically shows a hybrid drive of a motor vehicle having an internal combustion engine, an electric motor, and a disconnecting clutch or hybrid clutch for elucidating a regulation of the rotational speed or a torque of the electric motor via pre-control using a setpoint transmitted torque of the disconnecting clutch or hybrid clutch.

FIG. 2 illustrates the setpoint transmitted torque and the actual transmitted torque of the disconnecting clutch or hybrid clutch over time to elucidate the implementation of the setpoint transmitted torque when the disconnecting clutch or hybrid clutch is engaged.

FIG. 3 shows another schematic illustration of the hybrid drive to elucidate the regulation of the rotational speed or a torque of the electric motor via pre-control using a modified setpoint transmitted torque of the disconnecting clutch or hybrid clutch.

### DETAILED DESCRIPTION OF EXAMPLE EMBODIMENTS

Hybrid drive 1 of a motor vehicle, illustrated only partially and schematically in the figures, includes an internal combustion engine 2 and an electric motor 3, using which the vehicle may be driven purely electrically, i.e., using electric motor 3 alone with internal combustion engine 2 turned off, and/or using internal combustion engine 2 alone with electric motor 3 turned off, and/or in a hybrid operation, i.e., using both internal combustion engine 2 and electric motor 3, which in the last-mentioned case jointly delivers the drive torque for a drive train 8 of the vehicle leading to the driving wheels of the vehicle.

Usually a purely electric operation is preferred for a low driving power output, and internal combustion engine 2 is not turned on until either a higher driving power is requested or the capacity or charge state of a vehicle battery (not illustrated) forming the energy accumulator of electric motor 3 drops below a predefined threshold value.

The rotational speed of electric motor 3 is regulated with the aid of a speed regulator 6, which is supplied with a setpoint speed ωₛₑₜₚₒᵢₙₜ and an actual speed ω_{actual} of an output shaft 9 of electric motor 3, ascertained by a speed sensor 7. A sensorless speed regulation is also possible.

In purely electric operation, the rotational speed is regulated according to conventional regulation methods, in that speed regulator 6 outputs an output quantity in the form of a positioning torque M_{Stell} as a function of a difference between actual speed ω_{actual} and setpoint speed ωₛₑₜₚₒᵢₙₜ to modify a setpoint torque Mₛₑₜₚₒᵢₙₜ of electric motor 3 according to the difference between actual rotational speed ω_{actual} and setpoint speed ωₛₑₜₚₒᵢₙₜ.

In a transition from purely electric operation into the hybrid operation, internal combustion engine 2 is started from standstill using a so-called “slip start,” specifically with the aid of a disconnecting clutch or hybrid clutch 4 situated between internal combustion engine 2 and electric motor 3, which is slowly engaged in the purely electric operation to entrain internal combustion engine 2.

Disconnecting clutch or hybrid clutch 4 is designed as a so-called proportional clutch, in which a desired setpoint transmitted torque MÜₛₑₜₚₒᵢₙₜ may be set between output shaft 9 of electric motor 3 leading to the clutch and an output shaft 10 of internal combustion engine 2 also leading to the clutch, regardless of a speed difference between rotational speed ω_{actual} of electric motor 3 and the rotational speed of internal combustion engine 2. Such a proportional clutch may be designed, for example, as a friction clutch, a sliding clutch, or a slip clutch whose actual transmitted torque MÜ_{actual} may be controlled or regulated according to the desired setpoint transmitted torque MÜₛₑₜₚₒᵢₙₜ via the pressing force between two clutch faces.

Disconnecting clutch or hybrid clutch 4 is activated or actuated for starting internal combustion engine 2 by a hybrid operation control circuit 5 used for activating disconnecting clutch or hybrid clutch 4 where, in the purely electric operation, it is determined, as a function of performance quantities of the motor vehicle such as, for example, a driver request torque on the driving wheels, the capacity or charge state of the vehicle battery, and the like, whether or not internal combustion engine 2 is to be connected. When internal combustion engine 2 is to be started, disconnecting clutch or hybrid clutch 4 is activated by hybrid operation control circuit 5 using setpoint transmitted torque MÜₛₑₜₚₒᵢₙₜ, whereupon disconnecting clutch or hybrid clutch 4 is slowly engaged and an actual transmitted torque MÜ_{actual} transmitted from electric motor 3 to the internal combustion engine increases from zero until it reaches setpoint transmitted torque MÜₛₑₜₚₒᵢₙₜ.

When disconnecting clutch or hybrid clutch 4 is activated for transitioning into the hybrid operation, a torque, which is required when starting internal combustion engine 2 for overcoming the friction and for rotationally accelerating the crankshaft, is detracted from output shaft 9 of electric motor 3. This causes a sudden change in the torque at output shaft 9 of electric motor 3, which interferes with the speed regulation of electric motor 3, so that a great difference may arise between actual speed ω_{actual} and setpoint speed ωₛₑₜₚₒᵢₙₜ. Since this difference cannot be immediately compensated by speed regulator 6 due to the control delay, a perceptible jolt may be felt in the vehicle, unless appropriate countermeasures are taken.

To avoid this jolt, positioning torque M_{Stell} output by speed regulator 6 is corrected in an adding element 11 by adding a correction torque to positioning torque M_{Stell} before the corrected positioning torque is supplied to electric motor 3 as setpoint torque Mₛₑₜₚₒᵢₙₜ.

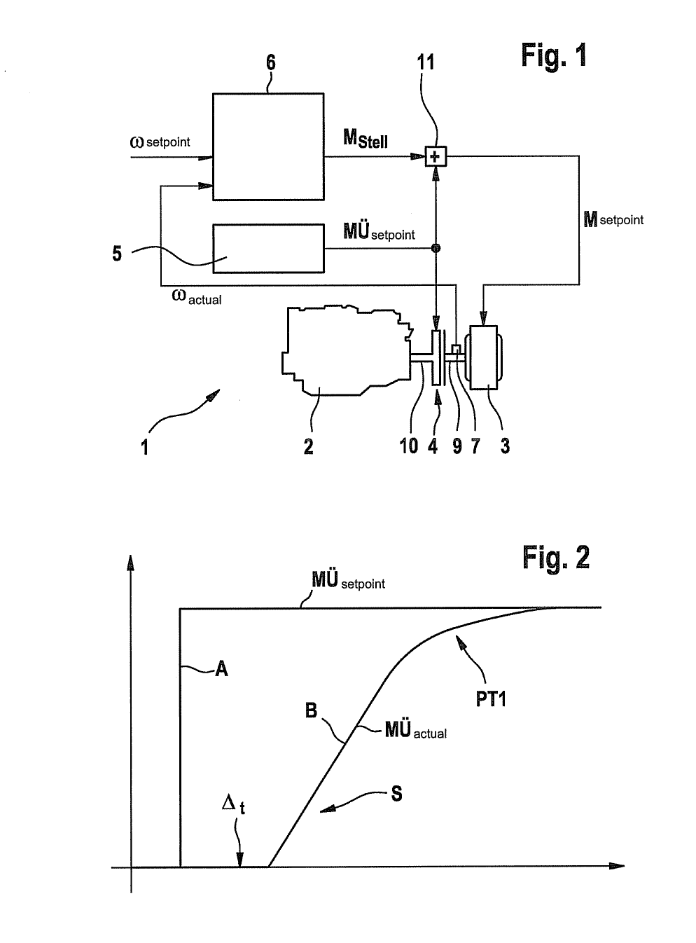

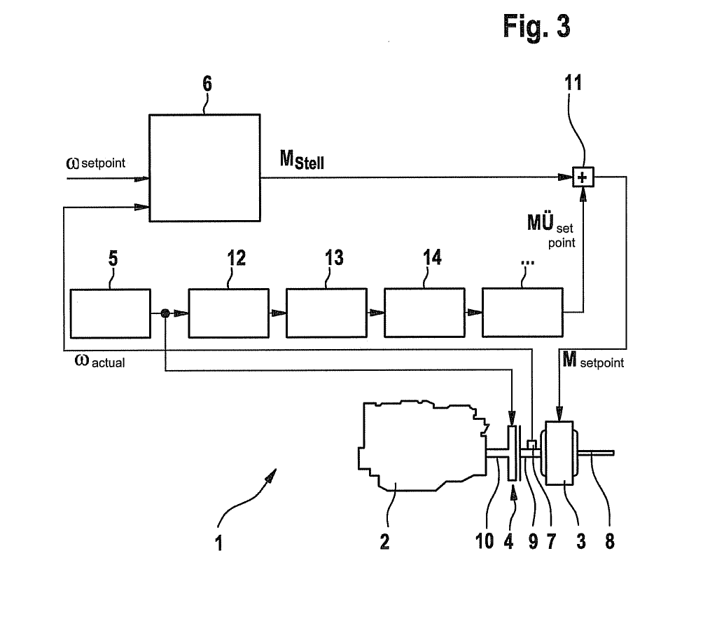

In hybrid drive 1 illustrated in FIG. 1, the correction torque added to positioning torque M_{Stell} corresponds to setpoint transmitted torque MÜₛₑₜₚₒᵢₙₜ set at disconnecting clutch or hybrid clutch 4 by hybrid operation controller 5. This transmitted torque illustrated by curve A in FIG. 3 has the value zero before disconnecting clutch or hybrid clutch 4 is activated and the desired value MÜₛₑₜₚₒᵢₙₜ after disconnecting clutch or hybrid clutch 4 is activated.

Since the time for implementing setpoint transmitted torque MÜₛₑₜₚₒᵢₙₜ in disconnecting clutch or hybrid clutch 4, i.e., the time from the activation of disconnecting clutch or hybrid clutch 4 by controller 5 until an actual transmitted torque MÜ_{actual} corresponding to the desired setpoint transmitted torque MÜₛₑₜₚₒᵢₙₜ is transmitted from electric motor 3 via disconnecting clutch or hybrid clutch 4 to internal combustion engine 2, approximately corresponds to the time for implementing setpoint torque Mₛₑₜₚₒᵢₙₜ in electric motor 3, i.e., the time for the addition of setpoint transmitted torque MÜₛₑₜₚₒᵢₙₜ to positioning torque M_{Stell} and implementation of an actual torque in electric motor 3 corresponding to corrected setpoint torque Mₛₑₜₚₒᵢₙₜ, the implementation of the setpoint transmitted torque MÜₛₑₜₚₒᵢₙₜ in disconnecting clutch or hybrid clutch 4 and the implementation of setpoint torque Mₛₑₜₚₒᵢₙₜ in electric motor 3 coincide in time. Thus, in the ideal case, the interfering torque transmitted to output shaft 9 due to the engagement of disconnecting clutch or hybrid clutch 4 is exactly compensated in the control loop, so that the slip start occurs without system deviation and the start of internal combustion engine 2 occurs without a perceptible jolt.

However, in this embodiment, disconnecting clutch or hybrid clutch 4 does not implement setpoint transmitted torque MÜₛₑₜₚₒᵢₙₜ according to ideal curve A illustrated in FIG. 3, but according to curve B illustrated in FIG. 3, which shows the variation of the actual transmitted torque MÜ_{actual} of disconnecting clutch or hybrid clutch 4. Compared to an ideal implementation of setpoint transmitted torque MÜₛₑₜₚₒᵢₙₜ as shown by curve A, there are a few differences in the case of this curve B: First, the increase in actual transmitted torque MÜ_{actual} only starts after a certain time delay Δt due to the propagation time of the CAN control signals. Second, the increase in actual transmitted torque MÜ_{actual} has a limited slope S due to a maximum displacement speed of an actuating element used for operating disconnecting clutch or hybrid clutch 4. Third, in systems of this type, an effect known as PT1 filtering is to be observed, namely a flattening of the slope when approaching the desired setpoint transmitted torque MÜₛₑₜₚₒᵢₙₜ.

To avoid this and other effects resulting in a system deviation in the speed regulation during the implementation of setpoint transmitted torque MÜₛₑₜₚₒᵢₙₜ in disconnecting clutch or hybrid clutch 4 in the case of slip start and to better emulate the behavior over time of disconnecting clutch or hybrid clutch 4, in the case of hybrid drive 1 illustrated in FIG. 2, setpoint transmitted torque MÜₛₑₜₚₒᵢₙₜ output by controller 5 should also be subjected to a time delay in 12, to a slope limitation in 13, and to PT1 filtering in 14, and to other modifications if necessary before being supplied to adding element 11, so that the correction of positioning torque M_{Stell} in adding element 11 corresponds, to the maximum degree possible, to the implementation of setpoint transmitted torque MÜₛₑₜₚₒᵢₙₜ in disconnecting clutch or hybrid clutch 4 in order to adjust, to the maximum degree possible, the variation of the actual torque of electric motor 3 both in time and magnitude to the change in torque in output shaft 9 caused by the engagement of disconnecting clutch or hybrid clutch 4.

1-12. (canceled)

13. A method for compensating a transmitted torque of a clutch between a regulated drive motor and an internal combustion engine of a hybrid drive when transitioning from an exclusive operation using the drive motor to a hybrid operation, a total torque from the drive motor and the internal combustion engine being jointly provided in hybrid operation, the method comprising:
one of controlling and regulating a rotational speed of the drive motor using a manipulated variable;
coupling the internal combustion engine to the drive motor via a proportional clutch having a controllable transmitted torque for carrying out the transition; and
one of controlling or regulating the rotational speed of the drive motor as a function of a setpoint transmitted torque at which the drive motor is to be coupled to the internal combustion engine.

14. The method as recited in claim 13, wherein the rotational speed of the drive motor is regulated to set an actual rotational speed to a setpoint rotational speed, the manipulated variable being modified as a function of the setpoint transmitted torque to obtain a corrected manipulated variable.

15. The method as recited in claim 14, wherein the manipulated variable corresponds to a positioning torque, the positioning torque being increased by the setpoint transmitted torque to obtain a corrected positioning torque as the corrected manipulated variable for activating the drive motor.

16. The method as recited in claim 14, wherein the setpoint transmitted torque is subjected to a time delay prior to the correction of the manipulated variable.

17. The method as recited in claim 14, wherein the setpoint transmitted torque is subjected to a slope limitation prior to the correction of the manipulated variable.

18. The method as recited in claim 14, wherein the setpoint transmitted torque is subjected to PT1 filtering prior to the correction of the manipulated variable.

19. The method as recited in claim 16, wherein the time delay is performed as a function of an operating temperature.

20. The method as recited in claim 17, wherein the slope limitation is performed as a function of an operating temperature.

21. The method as recited in claim 18, wherein the PT1 filtering is performed as a function of an operating temperature.

22. A device for compensating a transmitted torque between a regulated drive motor and an internal combustion engine of a hybrid drive when transitioning to a hybrid operation in which the internal combustion engine is started, the device comprising:
a rotational speed controller or regulator to control or regulate a rotational speed of the drive motor according to a manipulated variable;
a clutch to couple the internal combustion engine to the drive motor at a time of the transition, so that the internal combustion engine is entrained using a desired setpoint transmitted torque; and
a transmitted torque-providing device to provide the setpoint transmitted torque, the rotational speed controller or regulator being adapted to control or regulate the rotational speed of the drive motor as a function of the setpoint transmitted torque.

23. The device as recited in claim 22, wherein the rotational speed controller or regulator controls or regulates the rotational speed of the drive motor to set an actual rotational speed to a setpoint rotational speed, the setpoint transmitted torque acting upon the manipulated variable of the rotational speed controller or regulator being modified to obtain a corrected manipulated variable.

24. The device as recited in claim 23, wherein the manipulated variable corresponds to a positioning torque, and the device further comprises:
an adding unit to increase the positioning torque by the setpoint transmitted torque to obtain a corrected positioning torque as the corrected manipulated variable for activating the drive motor.

25. The device as recited in claim 22, wherein the transmitted torque-providing unit is a hybrid operation control circuit, which activates the clutch using the setpoint transmitted torque.

26. The device as recited in claim 25, further comprising:
a component adapted to modify the setpoint transmitted torque prior to correcting the manipulated variable, in which the setpoint transmitted torque may be subjected to at least one of a time delay, a slope limitation, and PT1 filtering.

27. The device as recited in claim 22, wherein the regulated drive motor is an electric motor.
